(19) United States
(12) Patent Application Publication
(10) Pub. No.: US 2016/0034142 A1
(43) Pub. Date: Feb. 4, 2016

(54) SELECTING AN ADJACENT FILE ON A DISPLAY OF AN ELECTRONIC DEVICE

(71) Applicant: Telefonaktiebolaget L M Ericsson (publ), Stockholm (SE)

(72) Inventors: Hongxin Liang, Upplands Vasby (SE); Dimitri Mazmanov, Solna (SE)

(21) Appl. No.: 14/418,388

(22) PCT Filed: Mar. 26, 2014
(86) PCT No.: PCT/SE2014/050362

§ 371 Date: Jan. 29, 2015

(51) Int. Cl. G06F 3/0484; G06F 3/0488; G06F 3/0482

(52) U.S. Cl. CPC G06F 3/04842; G06F 3/0482; G06F 3/04883

(57) ABSTRACT

Methods of operating an electronic device are provided. A method of operating an electronic device may include presenting a group of files on a display of the electronic device. The method may include accepting selection by a user, via a user interface of the electronic device, of a first one of the files. Moreover, the method may include selecting a second one of the files adjacent the first one of the files, based on the selection of the first one of the files by the user. Related electronic devices and computer program products are also provided.

### TECHNICAL FIELD

The present disclosure is directed to electronic devices and, more particularly, to user interfaces of electronic devices.

### BACKGROUND

Selecting items that are displayed on an electronic device may be cumbersome for a user because selecting specific ones of the items may involve several user actions/selections. Moreover, although some electronic devices may allow selection of groups of items, a group selection of multiple items may be imprecise because it may be over-inclusive or under-inclusive in comparison with the specific items that a user wants to select.

The approaches described in this Background section could be pursued, but are not necessarily approaches that have been previously conceived or pursued. Therefore, unless otherwise expressly stated herein, the approaches described in this Background section are not prior art to the claims in this application and are not admitted to be prior art by inclusion in this section.

### SUMMARY

Various embodiments may provide a method of operating an electronic device. The method may include presenting a group of files on a display of the electronic device. The method may include accepting selection by a user, via a user interface of the electronic device, of a first one of the files. Moreover, the method may include selecting a second one of the files adjacent the first one of the files, based on the selection of the first one of the files by the user.

An electronic device, according to various embodiments, may be provided. The electronic device may include a display and a user interface configured to provide navigation of the display by a user of the electronic device. Moreover, the electronic device may include a processor configured to present a group of files on the display and to accept selection by the user, via the user interface, of a first one of the files. Based on the selection of the first one of the files by the user, the processor may be configured to select a second one of the files that is adjacent the first one of the files.

A computer program product, according to various embodiments, may be provided. The computer program product may include a tangible computer readable storage medium including computer readable program code therein that when executed by a processor causes the processor to perform operations including presenting a group of files on a display of an electronic device and accepting selection by a user, via a user interface of the electronic device, of a first one of the files. Moreover, based on the selection of the first one of the files by the user, the operations may include selecting a second one of the files that is adjacent the first one of the files.

Accordingly, various embodiments described herein may allow a user of an electronic device to control selection of files on a display of the electronic device without requiring cumbersome actions/selections by the user. For example, according to various embodiments described herein, a user of an electronic device may control a time range within which a plurality of photographs (e.g., photographs in an electronic gallery) will be selected automatically on a display of the electronic device. In particular, various embodiments described herein may provide a more precise (e.g., finer-grained) selection among photographs on a display of an electronic device without necessarily having to explicitly specify a range that includes the desired photographs and without having to individually select each of the desired photographs. Various embodiments described herein may therefore provide an enhanced user experience when a user of an electronic device wants to select a group of photographs (or other files) that are displayed on the electronic device.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of inventive concepts. In the drawings:

FIG. 1A is a schematic diagram of a communication system that includes an electronic device according to some embodiments;

FIGS. 1B and 1C illustrate examples of an electronic device according to some embodiments;

FIG. 2 is a block diagram of an electronic device according to some embodiments;

FIGS. 3A-3O are flow charts illustrating operations of an electronic device according to some embodiments; and

FIGS. 4A-4H illustrate screenshots of a display of an electronic device according to some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

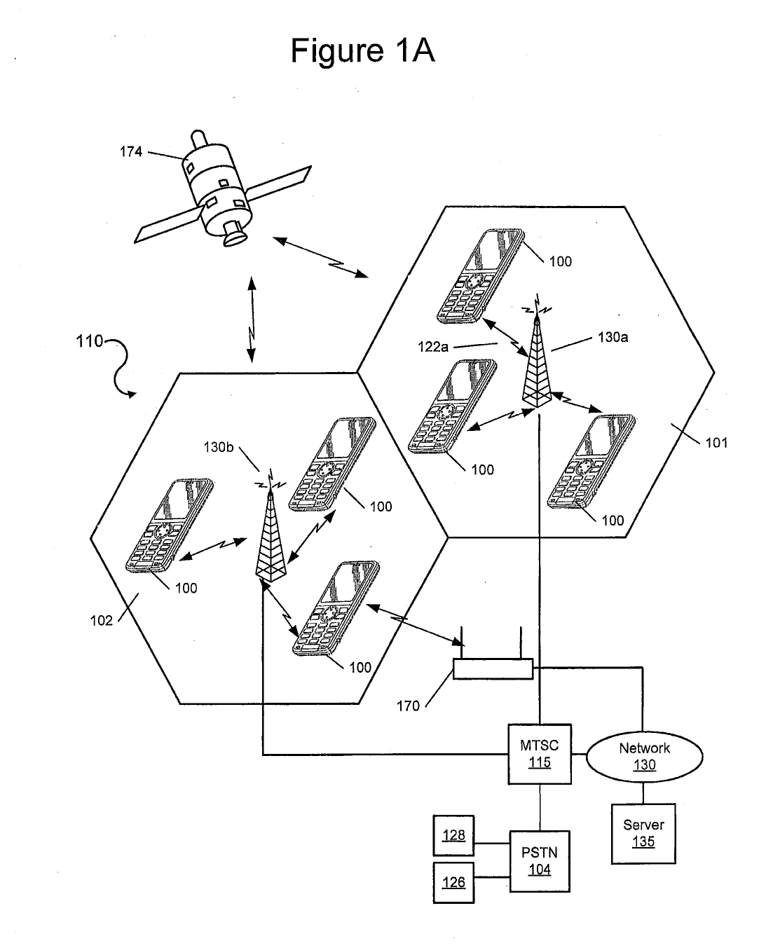

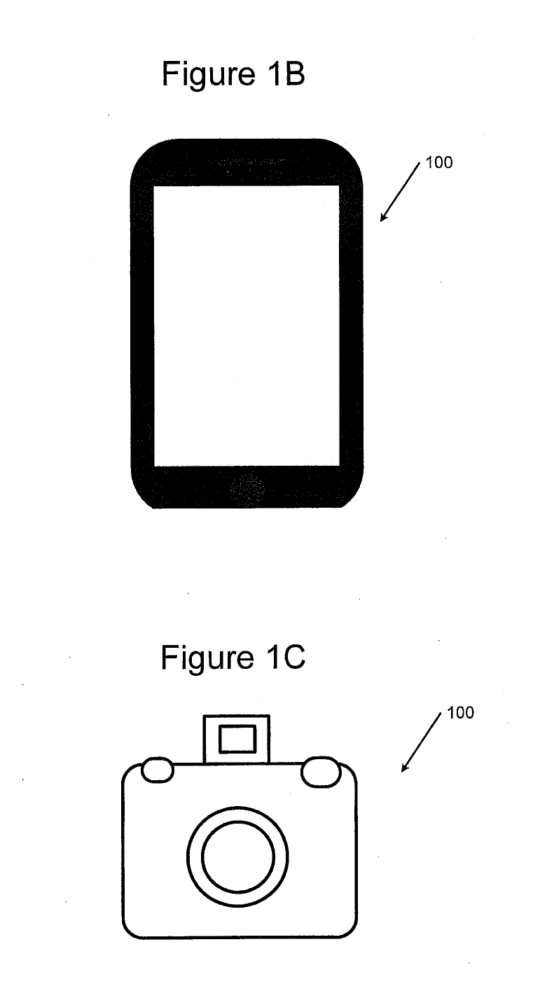

Referring to FIG. 1A, a schematic diagram is provided of a wireless communication network 110 that supports communications in which electronic devices 100 can be used according to various embodiments of present inventive concepts. The network 110 may include cells 101, 102 and base stations 130a, 130b in the respective cells 101, 102. Networks 110 may be used to provide voice and data communications to subscribers using various radio access standards/technologies. The network 110 illustrated in FIG. 1A may include electronic devices 100 that may communicate with the base stations 130a, 130b. The electronic devices 100 in the network 110 may additionally or alternatively communicate with a Global Positioning System (GPS) satellite 174, a local wireless network 170, a Mobile Telephone Switching Center (MTSC) 115, and/or a Public Service Telephone Network (PSTN) 104 (i.e., a “landline” network).

The electronic devices 100 can communicate with each other via the MTSC 115. The electronic devices 100 can also communicate with other devices/terminals, such as terminals 126, 128, via the PSTN 104 that is coupled to the network 110. As also shown in FIG. 1A, the MTSC 115 may be coupled to a computer server 135 via a network 130, such as the Internet.

The network 110 may be organized as cells 101, 102 that collectively can provide service to a broader geographic region. In particular, each of the cells 101, 102 can provide service to associated sub-regions (e.g., regions within the hexagonal areas illustrated by the cells 101, 102 in FIG. 1A) included in the broader geographic region covered by the network 110. More or fewer cells can be included in the network 110, and the coverage areas for the cells 101, 102 may overlap. The shape of the coverage area for each of the cells 101, 102 may be different from one cell to another and is not limited to the hexagonal shapes illustrated in FIG. 1A. The base stations 130a, 130b in the respective cells 101, 102 can provide wireless communications between each other and the electronic devices 100 in the associated geographic region covered by the network 110.

Each of the base stations 130a, 130b can transmit/receive data to/from the electronic devices 100 over an associated control channel. For example, the base station 130a in cell 101 can communicate with one of the electronic devices 100 in cell 101 over the control channel 122a. The control channel 122a can be used, for example, to page the electronic device 100 in response to calls directed thereto or to transmit traffic channel assignments to the electronic device 100 over which a call associated therewith is to be conducted.

The electronic devices 100 may also be capable of receiving messages from the network 110 over the respective control channels 122a. In various embodiments, the electronic devices 100 may receive Short Message Service (SMS), Enhanced Message Service (EMS), Multimedia Message Service (MMS), and/or Smartmessaging™ formatted messages.

The GPS satellite 174 can provide GPS information to the geographic region including cells 101, 102 so that the electronic devices 100 may determine location information. The network 110 may also provide network location information as the basis for the location information applied by the electronic devices 100. In addition, the location information may be provided directly to the server 135 rather than to the electronic devices 100 and then to the server 135. Additionally or alternatively, the electronic devices 100 may communicate with the local wireless network 170 (e.g., Wi-Fi or Bluetooth).

FIGS. 1B and 1C illustrate examples of an electronic device 100 according to some embodiments. In particular, although the electronic devices 100 in FIG. 1A are illustrated as mobile/cellular telephones, an electronic device 100 herein is not limited to mobile/cellular telephones. Rather, as used herein, an electronic device 100 (also referred to as a User Equipment (UE) or wireless terminal) may include, but is not limited to, a mobile/cellular telephone, a tablet computer, a laptop/portable computer, a pocket computer, a hand-held computer, a desktop computer, and/or a camera. Specifically, the term electronic device 100, as used herein, may include any device that can present electronic files on a display and accept user selection of the electronic files. For example, FIG. 1B illustrates that an electronic device 100 may be a tablet computer, and FIG. 1C illustrates that an electronic device 100 may be a camera (e.g., a standalone/dedicated camera). Moreover, according to some embodiments, wireless/wired connectivity of the electronic device 100 is not required.

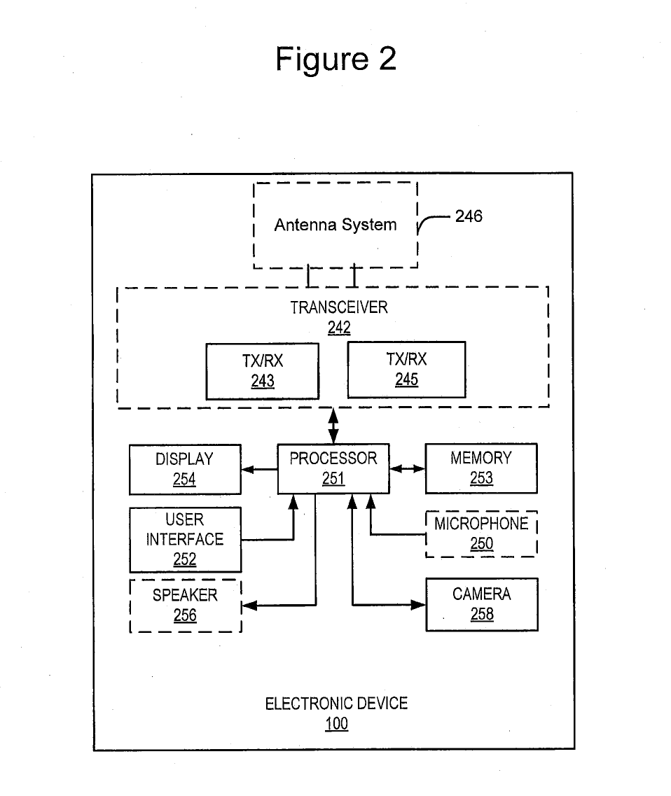

FIG. 2 is a block diagram of an electronic device 100 according to some embodiments. As illustrated in FIG. 2, an electronic device 100 may include a display 254, a user interface 252, a processor (e.g., processor circuit) 251, a memory 253, and a camera 258. Moreover, the electronic device 100 may optionally include an antenna system 246, a transceiver 242, a speaker 256, and/or a microphone 250. Although cellular wireless connectivity is discussed by way of example, other wireless connectivity (e.g., Wi-Fi, Bluetooth, etc.) may be provided instead of, or in addition to, cellular wireless connectivity, or wireless connectivity may be omitted altogether.

A transmitter portion of the transceiver 242 may convert information, which is to be transmitted by the electronic device 100, into electromagnetic signals suitable for radio communications (e.g., to the network 110 illustrated in FIG. 1A). A receiver portion of the transceiver 242 may demodulate electromagnetic signals, which are received by the electronic device 100 from the network 110 to provide the information contained in the signals in a format understandable to a user of the electronic device 100. The transceiver 242 may include transmit/receive circuitry (TX/RX) that provides separate communication paths for supplying/receiving RF signals to different radiating elements of the antenna system 246 via their respective RF feeds. Accordingly, when the antenna system 246 includes two active antenna elements, the transceiver 242 may include two transmit/receive circuits 243, 245 connected to different ones of the antenna elements via the respective RF feeds.

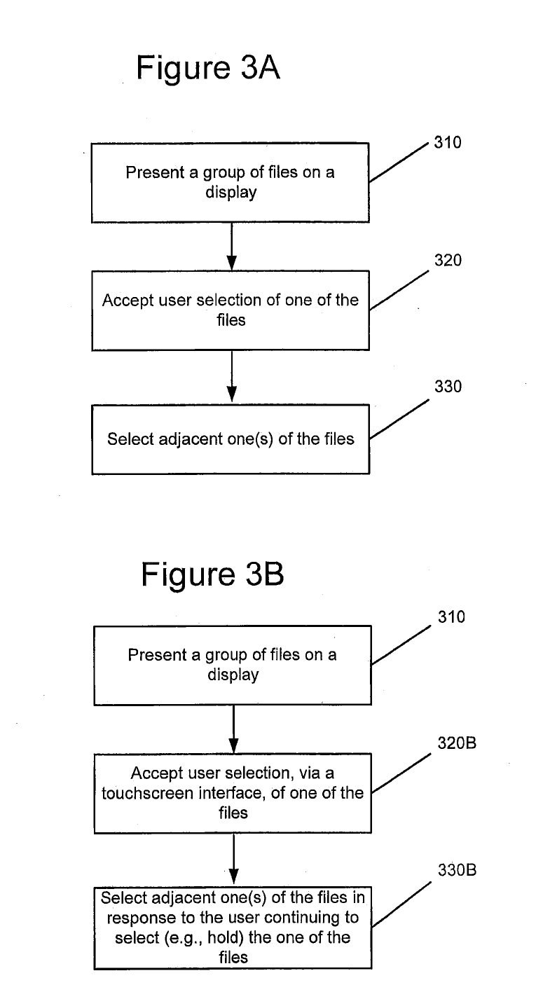

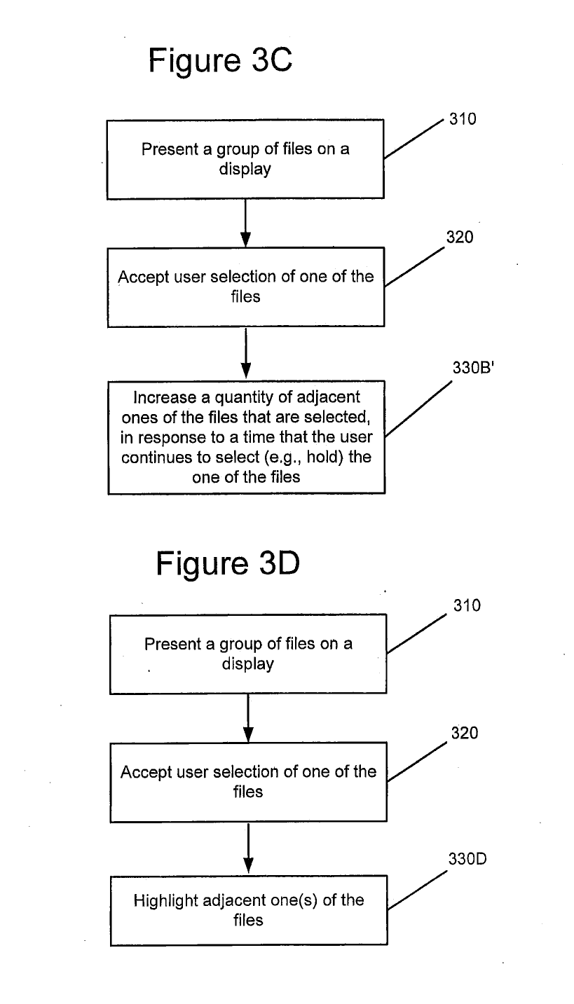

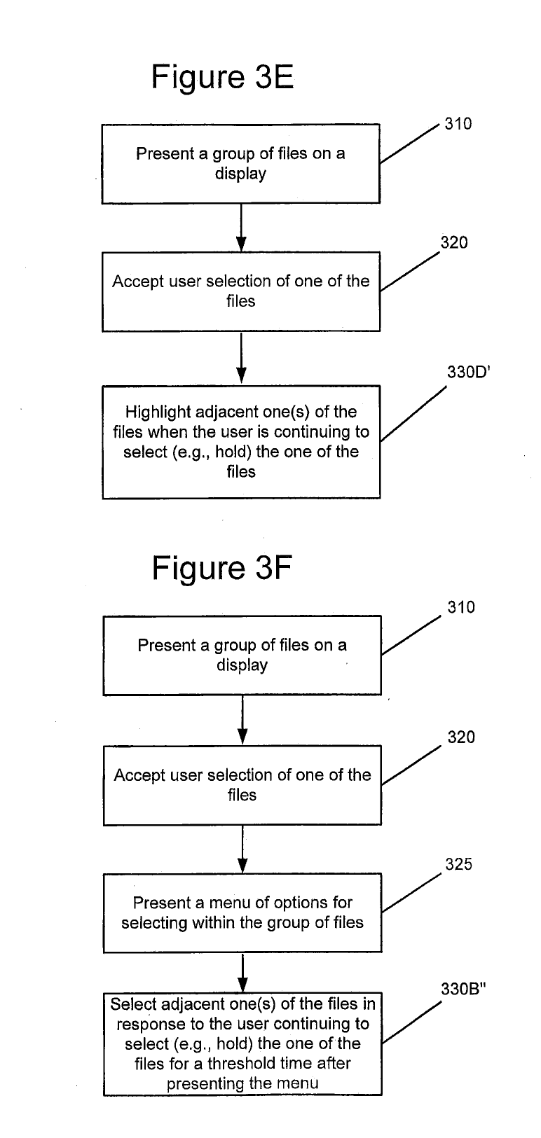

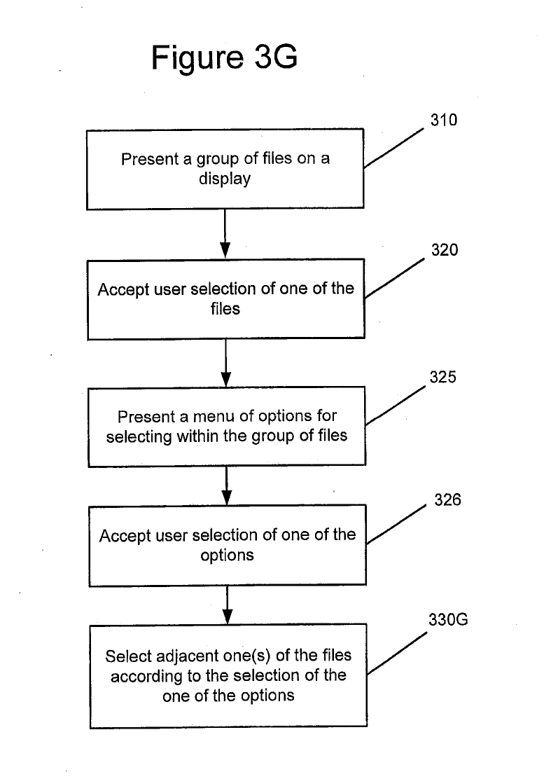

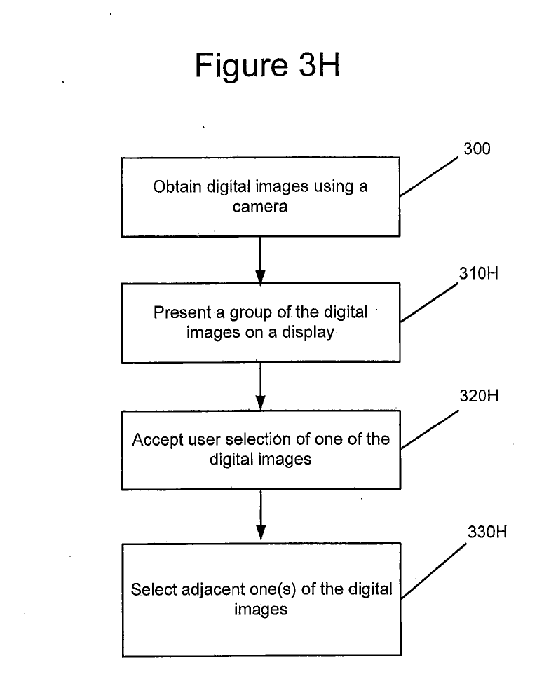

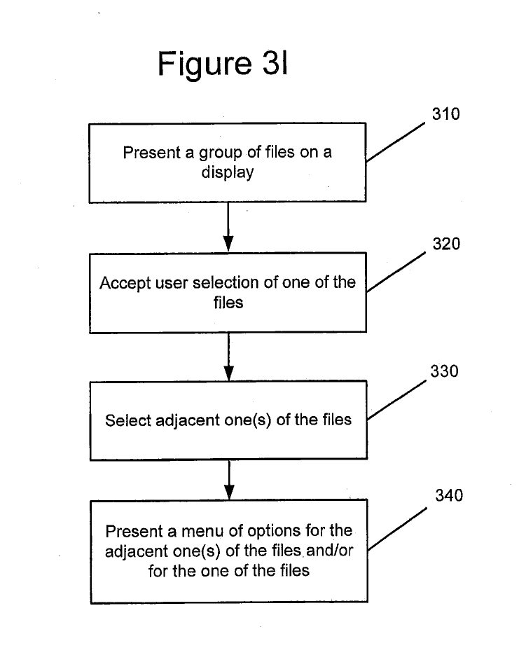

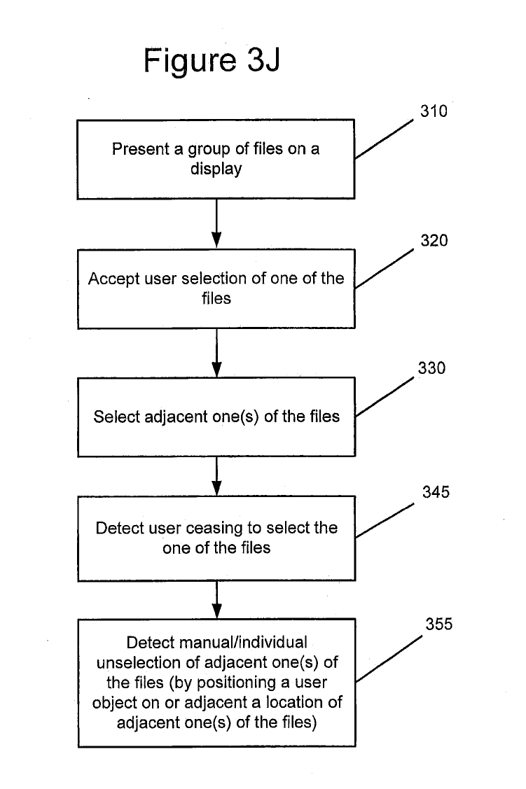

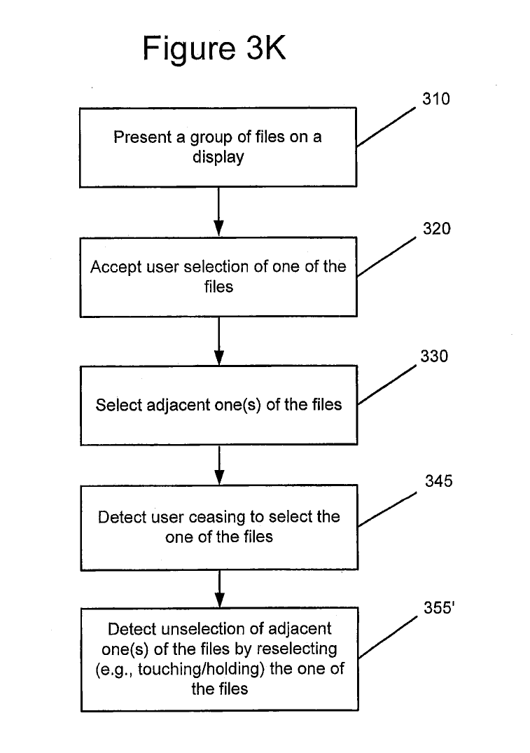

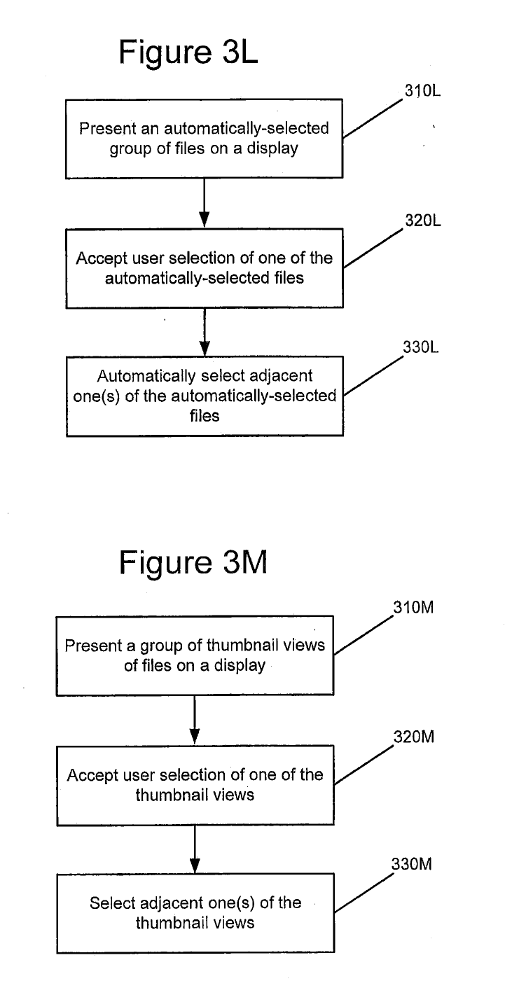

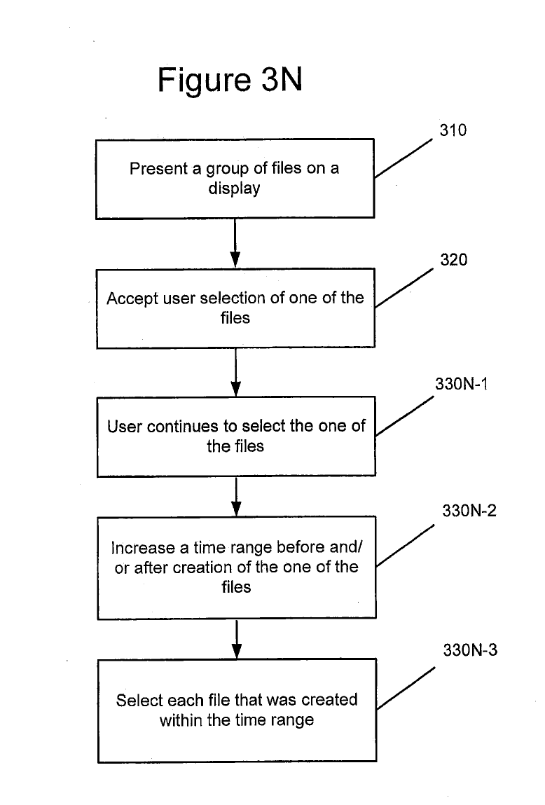

The electronic device 100 is not limited to any particular combination/arrangement of the user interface 252 and the display 254. For example, the user interface 252 may be an input interface that accepts inputs (e.g., touch, click, motion, proximity, or keypad inputs) from the user. Moreover, the display 254 may be referred to as a user interface that provides graphical/visual outputs to the user. As an example, the functions of the user interface 252 and the display 254 may be provided by a touch screen through which the user can view information, such as computer-displayable files, provide input thereto, and otherwise control the electronic device 100. In particular, regardless of whether the electronic device 100 is a mobile/cellular telephone, a tablet computer, a dedicated/standalone camera, or another device, the operations described herein (e.g., as illustrated in the flow charts of FIGS. 3A-3O) may be performed using a touch screen that provides/integrates the user interface 252 and the display 254. Additionally or alternatively, the electronic device 100 may include a separate user interface 252 and display 254. For example, user input may be accepted through a touchpad, a mouse, or another user input interface that is separate from the display 254.

Referring still to FIG. 2, the memory 253 can store computer program instructions that, when executed by the processor circuit 251, carry out operations of the electronic device 100 (e.g., as illustrated in the flow charts of FIGS. 3A-3O). As an example, the memory 253 can be non-volatile memory, such as a flash memory, that retains the stored data while power is removed from the memory 253.

FIGS. 3A-3O are flow charts illustrating operations of an electronic device 100 according to some embodiments. Referring to FIG. 3A, the operations may include presenting (Block 310) a group of files on the display 254 of the electronic device 100. For example, the electronic device 100 may present the group of files in chronological order (e.g., in order of when the files were created and/or stored in the electronic device 100). Accordingly, in some embodiments, files in the group that are physically adjacent on the display 254 may also be adjacent chronologically. Additionally or alternatively, the electronic device 100 may present the group of files on the display 254 by presenting icons representing respective ones of the files.

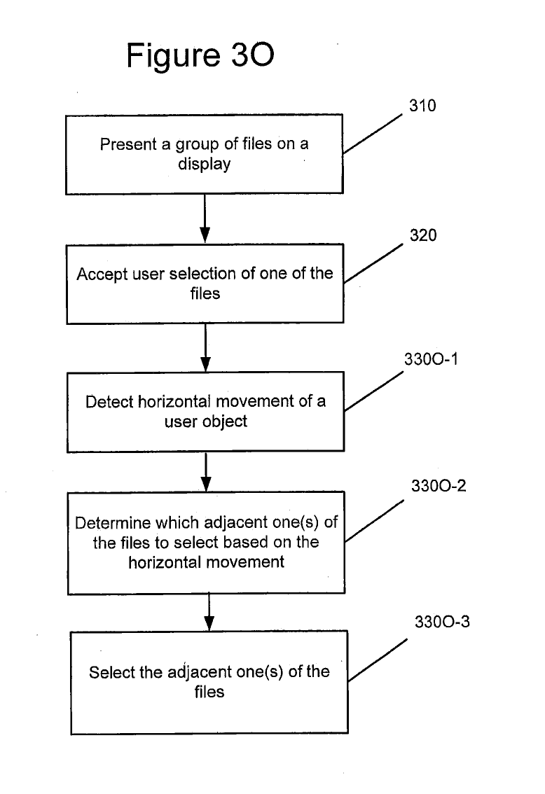

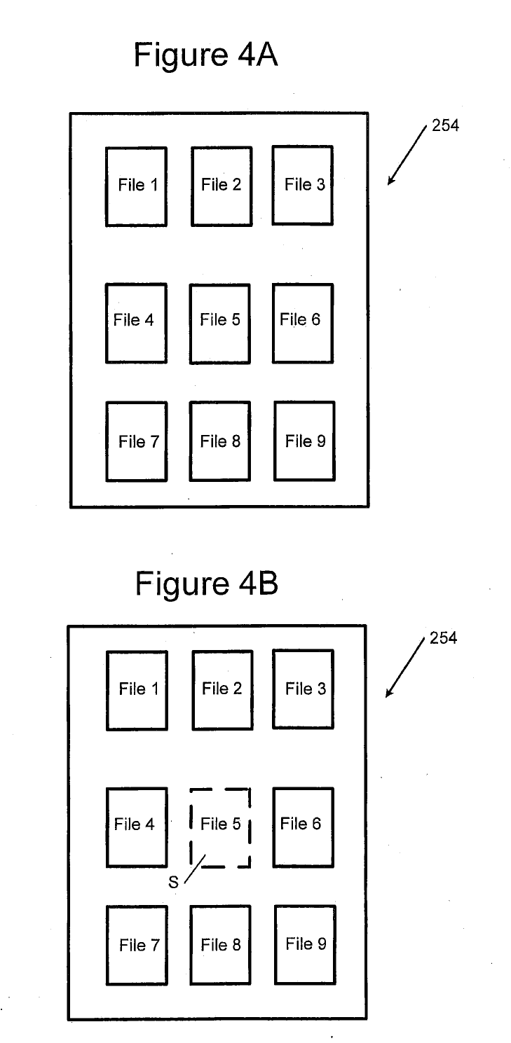

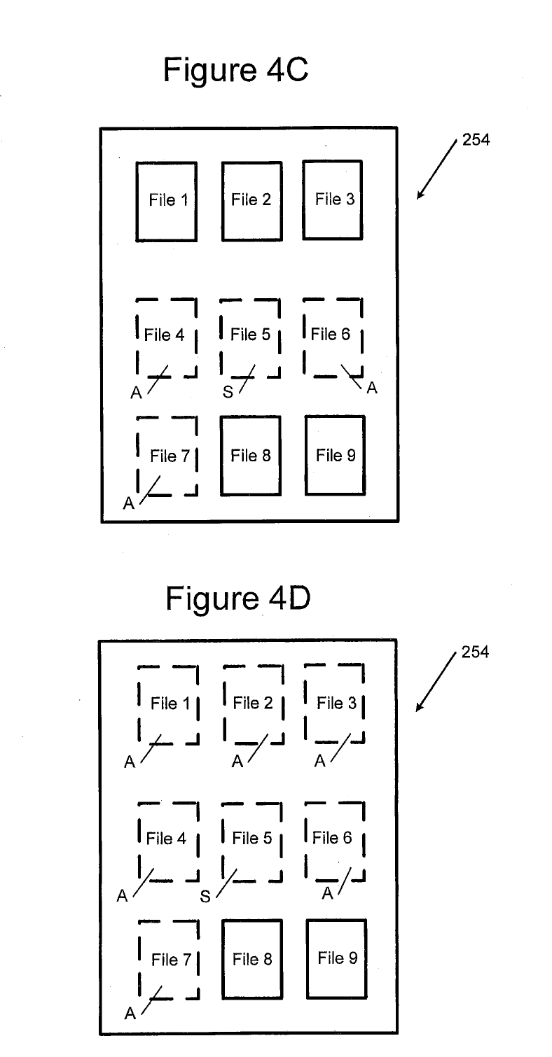

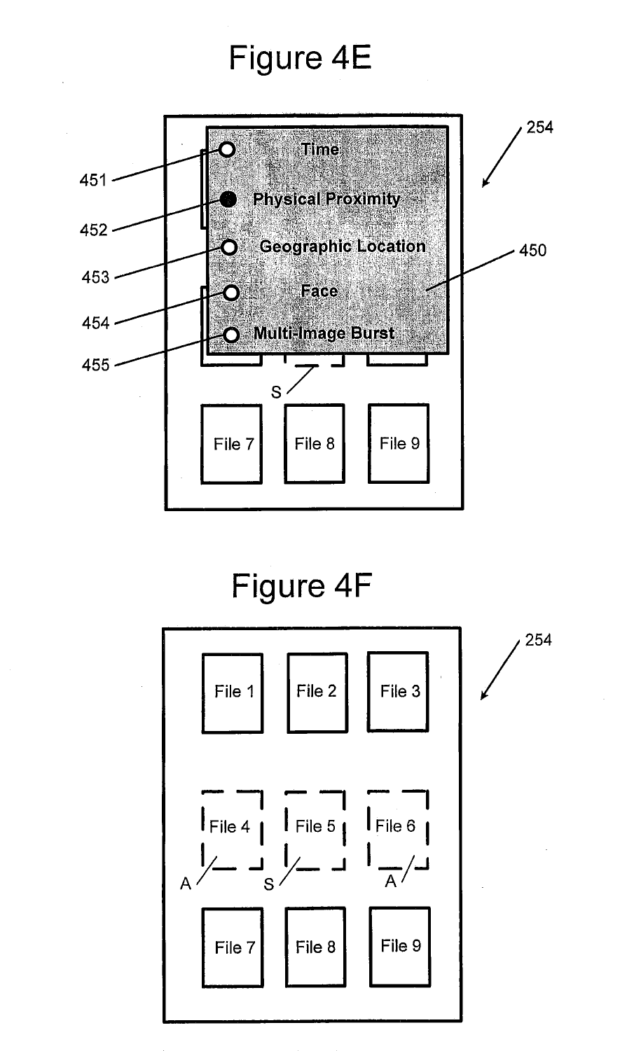

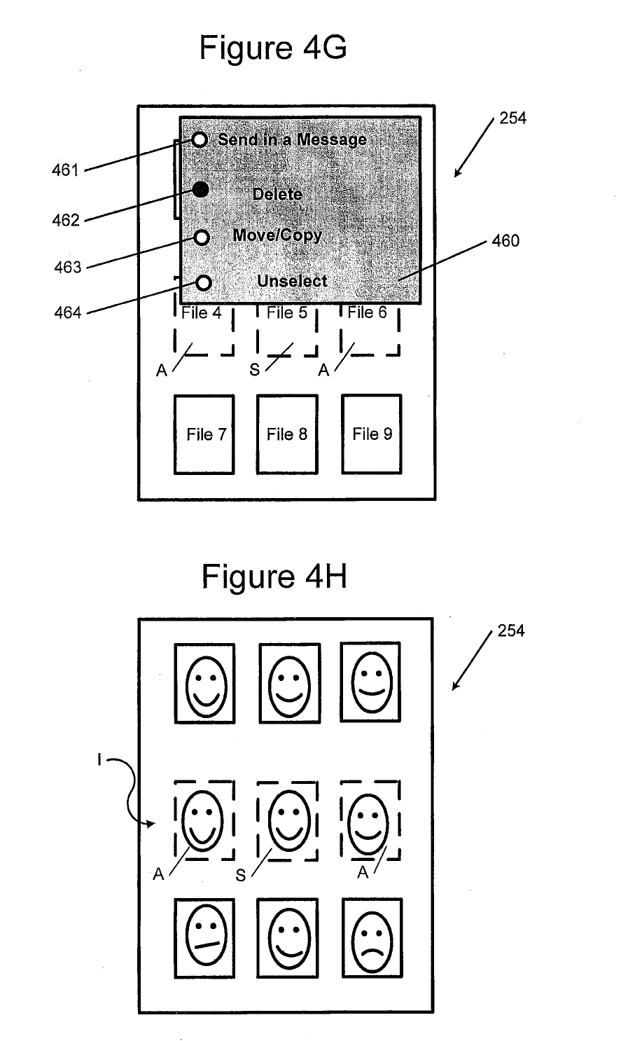

Referring still to FIG. 3A, the operations may include accepting (Block 320) selection by a user, via the user interface 252 of the electronic device 100, of a first one S of the files. For example, FIG. 4B, which will be described in detail below, illustrates selection, by the user, of the first one S of the files on the display 254. Moreover, based on the selection of the first one S of the files by the user, the operations may include selecting (Block 330) a second one (or more) A of the files adjacent the first one S of the files. For example, FIG. 4C, which will be described in detail below, illustrates selection, by the electronic device 100, of the second one (or more) A of the files on the display 254.

Referring now to FIG. 3B, the user interface 252 may include a touch screen interface of the display 254. Accordingly, operations of accepting (Block 320) the selection may include accepting (Block 320B) the selection by the user, via the touch screen interface, of the first one S of the files. Moreover, operations of selecting (Block 330) the second one (or more) A of the files may include selecting (Block 330B) the second one (or more) A of the files in response to the user continuing to select (e.g., by continuing to hold/touch), via the touch screen interface, the first one S of the files, after the electronic device 100 accepts (Block 320B) the selection of the first one S of the files.

Referring now to FIG. 3C, operations of selecting (Block 330) the second one (or more) A of the files may include selecting a plurality of second ones A of the files and increasing (Block 330B′) a quantity of the plurality of second ones A of the files that are selected adjacent the first one S of the files, in response to a quantity of time that the user continues to select (e.g., by continuing to hold/touch) the first one S of the files.

Referring now to FIG. 3D, operations of selecting (Block 330) the second one (or more) A of the files may include highlighting (Block 330D) the second one (or more) A of the files on the display 254, based on the selection of the first one S of the files by the user. Moreover, the selection of the first one S of the files by the user may result in highlighting of the first one S of the files on the display 254. As an example, FIG. 4C (which will be described in detail below) illustrates highlighting Files 4-7. As used herein, highlighting may refer to changing and/or adding a color/shading, size, shape, orientation, label, font, symbol, and/or border/perimeter of a graphical representation of one or more files on the display 254, or otherwise emphasizing the graphical representation of the one or more files on the display 254.

Referring now to FIG. 3E, operations of selecting (Block 330) the second one (or more) A of the files may include highlighting (Block 330D′) the second one (or more) A of the files on the display 254 when/because the user is continuing to select (e.g., by continuing to hold/touch) the first one S of the files.

Referring now to FIG. 3F, operations of the electronic device 100 may include presenting (Block 325) a menu 450 that includes one or more options 451-455 for selecting within the group of files, responsive to selection by the user of the first one S of the files. The menu 450 and the one or more options 451-455 may be presented on the display 254 as illustrated in FIG. 4E, which will be described in detail below, or may be presented on the display 254 in any other style/format that is selectable by the user. Moreover, operations of selecting (Block 330) the second one (or more) A of the files may include selecting (Block 330W) the second one (or more) A of the files in response to detection that the user is continuing to select (e.g., by continuing to hold/touch) the first one S of the files for a threshold amount of time after presenting (Block 325) the menu 450. As an example, the electronic device 100 may automatically select the second one (or more) A of the files based on time of file creation/storage (option 451), after the threshold amount of time. Accordingly, the user may bypass manual selection (by the user) from within the menu 450 and may instead cause the electronic device 100 to automatically select a default option (e.g., option 451 or option 452) by continuing to select the first one S of the files.

Referring, for example, to FIGS. 3B, 3C, 3E, and 3F, actions by the user of continuing to select the first one S of the files may correspond to operations by the electronic device 100 of detection of holding a user object of the user on or adjacent a location of the first one S of the files on the display 254. As used herein, a user object may refer to a finger of the user or a stylus or other object held by/connected to the user. Operations by the electronic device 100 of detection of the user object may include detection of touch and/or proximity of the user object with respect to the display 254/user interface 252. Accordingly, in some embodiments, actions by the user of holding the user object may include holding the user object in contact with the display 254/user interface 252 and/or holding the user object substantially still in a position that is in close proximity with the display 254/user interface 252. Moreover, in some embodiments, a mouse/pointer/cursor may be held and/or left-clicked on the first one S of the files to select and hold the first one S of the files.

Referring now to FIG. 3G, operations of presenting (Block 325) the menu 450, which includes one or more of the options 451-455 that are used to select within the group of files, are performed after the selection by the user of the first one S of the files. Moreover, operations performed by the electronic device 100 may include accepting (Block 326) selection by the user, via the user interface 252, of one of the options 451-455 from the menu 450. Moreover, operations of selecting (Block 330) the second one (or more) A of the files may include selecting (Block 330G) the second one (or more) A of the files according to the user's selection of the one of the options 451-455 from the menu 450.

Referring now to FIG. 3H, the group of files may include a group of digital images I (e.g., the digital photographs/images I illustrated in FIG. 41-1, which will be described in detail below). Operations of the electronic device 100 of presenting (Block 310) the group of files may include presenting (Block 310H) the group of digital images I on the display 254. Operations of accepting (Block 320) the selection may include accepting (Block 320H) a selection by the user of a first one S of the digital images I. Moreover, operations of selecting (Block 330) the second one (or more) A of the files may include selecting (Block 330H) a second one (or more) A of the digital images I adjacent the first one S of the digital images I, based on the selection of the first one S of the digital images (I) by the user. Referring still to FIG. 3H, the operations may include obtaining/capturing (Block 300) the digital images I using the camera 258 of the electronic device 100, before presenting (Block 310) the group of digital images I on the display 254.

Referring again to FIG. 3H, in some embodiments, the first one S of the digital images I may be associated with a geographic location, and the second one (or more) A of the digital images I may be associated with the same geographic location. Accordingly, the second one (or more) A of the digital images I may be selected (Block 330H) based on the association with the geographic location. For example, the association may be that the first one S of the digital images I and the second one (or more) A of the digital images I were obtained at the geographic location, or that the second one (or more) A of the digital images I was/were obtained at a geographic location(s) within a threshold distance from a first location of the first one S of the digital images I, the threshold distance defining a proximity to the first location. As an example, the association may be that the camera 258 captured the first one S of the digital images I and the second one (or more) A of the digital images I at the same geographic location (e.g., a particular town, city, state, country, landmark, home, business, set of coordinates, or other location). Additionally or alternatively, the association may be that the first one S of the digital images I and the second one (or more) A of the digital images I have been tagged/indicated/described (e.g., by the user or another entity) with a name/identifier of the geographic location.

In some embodiments, the second one (or more) A of the digital images I may include a human face that is included in the first one S of the digital images I. Accordingly, the second one (or more) A of the digital images I may be selected (Block 310H) based on including the same person's face. In some embodiments, operations of the electronic device 100 may include facial-recognition operations for the digital images I.

In some embodiments, the second one (or more) A of the digital images I may include a plurality of the digital images I that were obtained in a multi-image burst that includes the first one S of the digital images I. The multi-image burst may be defined as a burst/collection of the digital images obtained, using the camera 258, within a threshold amount of time (e.g., one, two, three, four, or five seconds, or an even smaller quantity of time). Moreover, operations of selecting (Block 330H) the second one (or more) A of the digital images I may include selecting (e.g., automatically selecting) the multi-image burst based on the selection of the first one S of the digital images I by the user.

Referring now to FIG. 3I, operations of the electronic device 100 may include presenting (Block 340) on the display 254 a menu 460 of one or more options 461-464 for the second one (or more) A of the files and/or the first one S of the files, after selecting (Block 330) the second one A of the files. The menu 460 and the one or more options 461-464 may be presented on the display 254 as illustrated in FIG. 4G, which will be described in detail below, or may be presented on the display 254 in any other style/format that is selectable by the user.

Referring now to FIG. 3J, the user may unselect one or more of the adjacent ones A of the files that have been selected. For example, the user may have accidentally over-selected the adjacent ones A of the files. Accordingly, FIG. 3J illustrates that operations of the electronic device 100 may include accepting un-selection of the second one (or more) A of the files by detecting positioning (Block 355) of the user object of the user on or adjacent a location of the second one (or more) A of the files on the display 254, after selection of the first S and second A ones of the files. Moreover, operations of the electronic device 100 may include detecting (Block 345) that the user has ceased/stopped selecting the first one S of the files, after the selection occurring in Block 330. For example, the user may lift/remove the user object from the first one S of the files.

Accordingly, referring again to Block 355 of FIG. 3J, the user may manually/individually unselect an adjacent one A of the files that has been selected. In particular, the user may manually/individually unselect the adjacent one A of the files by touching/tapping a position on the display 254 that indicates the particular adjacent one A of the files and/or by holding (e.g., in the case of a proximity-sensitive display 254/user interface 252) the user object in close proximity with that position.

Referring now to FIG. 3K, operations of the electronic device 100 may include accepting un-selection of the second one (or more) A of the files by detecting re-selection (Block 355′) by the user of the first one S of the files via the touch screen interface, after selection of the first S and second A ones of the files. In other words, the user may unselect one or more adjacent ones A of the files that have been selected, by re-selecting the first one S of the files after the selection occurring in Block 330.

Referring now to FIG. 3L, the group of files may be an automatically-selected group of files. For example, in embodiments where the group of files is a group of digital images I, the electronic device 100 may automatically form a group of the digital images I. As an example, the electronic device 100 may automatically group the digital images I as being associated with a time period, such as a particular day. The automatically-selected group is not limited to being associated with the same day, however, and may additionally or alternatively be grouped based on other time periods and/or other categories. Accordingly, the present inventive entity appreciates that the user may want to select digital images I that are within an automatically-selected group of digital images I.

Referring still to FIG. 3L, the first S and second A ones of the files may be adjacent first S and second A ones of the files within the automatically-selected group of files. Operations of selecting (Block 330) the second one (or more) A of the files may include automatically selecting (Block 330L) the second one (or more) A of the files within the automatically-selected group of files, based on the manual/direct/individual selection by the user of the first one S of the files within the automatically-selected group of files. Moreover, Blocks 310L and 320L illustrate that the operations of Blocks 310 and 320, respectively, may be performed with respect to the automatically-selected group of files.

Referring now to FIG. 3M, the files described herein may be represented on the display 254 using respective thumbnail representations/views of the files. Accordingly, the selection of the first one S of the files by the user may include a selection of a thumbnail view of the first one S of the files by the user. Moreover, operations of selecting (Block 330) the second one (or more) A of the files may include selecting (Block 330M) a thumbnail view of the second one A of the files (or respective thumbnail views of a plurality of second ones A of the files) based on the selection of the thumbnail view of the first one S of the files by the user.

A thumbnail view, as used herein, may refer to an icon or other representative image on the display 254 for a file. In some embodiments, the thumbnail view may be a reduced view of the file (e.g., a reduced-size view of a digital photograph).

Referring still to FIG. 3M, operations of presenting (Block 310) the group of files may include presenting (Block 310M) the group of thumbnail views of the files on the display 254. For example, the electronic device 100 may present the thumbnail views of the files on the display 254 in chronological order. Operations of accepting (Block 320) user selection of the first one S of the files may include accepting (Block 320M) user selection of the first one S of the thumbnail views of the files.

Referring now to FIG. 3N, operations of selecting (Block 330) the second one (or more) A of the files may include increasing (Block 330N-2) a time range before and/or after creation/storage of the first one S of the files, in response to a quantity of time that the user continues (Block 330N-1) to select (e.g., by continuing to hold/touch) the first one S of the files. Moreover, the operations of selecting (Block 330) the second one (or more) A of the files may include selecting (Block 330N-3) each one of the files that were created within the time range. For example, in embodiments where the files are digital images I, the user may increase the time range by continuing to select the first one S of the digital images I, and may thereby more precisely select a greater quantity of the adjacent ones A of the digital images I using a user-specified time range, without requiring the user to perform cumbersome operations (e.g., operations involving several movements/taps/touches/clicks).

Operations of FIG. 3N may thus allow the user to select adjacent ones A of the digital images I within a time range (e.g., a range of seconds, minutes, hours, or days) that is determined based on the user's continued selection of the first one S of the digital images I. For example, the user's continued selection of the first one S of the digital images I may cause the time range to increase from one second to five seconds, from five seconds to ten seconds, from ten seconds to thirty seconds, from thirty seconds to one minute, and then to one or more values greater than one minute. The specific increases in time, however, may or may not be linear/incremental, and may not necessarily be limited to the above-described example values of one second, five seconds, etc.

Alternatively, in response to accepting (Block 320) selection by the user, via the user interface 252 of the electronic device 100, of the first one S of the files, the electronic device 100 may graphically present a user-selectable/adjustable time range on the display 254. For example, the electronic device 100 may present a user-selectable slider that allows the user to specify selection of any adjacent A digital images I within a quantity of seconds, minutes, hours, or days of the first one S of the files by sliding the slider. For example, the user may use one slider to select any adjacent A digital images I that were captured within five seconds before the first one S of the files. As an additional or alternative example, the user may use another slider to select any adjacent A digital images I that were captured within six seconds after the first one S of the files. Moreover, such sliders on the display 254 are non-limiting examples, and various other forms of user adjustment/selection (e.g., by scrolling through values or by typing values) via the display 254/user interface 252 may be used by the user to specify the time range(s).

Accordingly, the inventive entity appreciates that the user may want to select adjacent A digital images I that were captured within a specific time range (e.g., a time range determined using the operations illustrated in FIG. 3N or determined using a slider or other form of adjustment/selection). For example, the user's child may capture several photographs within a one-minute time span by continuing to press a button that controls the camera 258 of the electronic device 100. The user may therefore want to delete all of the photographs that the child captured within the one-minute time span. Instead of having to manually/individually select and delete each of the photographs, various embodiments herein (e.g., as illustrated in FIG. 3N) may allow the user to control the electronic device 100 to automatically select all of the photographs that the child captured within the one-minute time span. In particular, although the electronic device 100 may have already grouped the photographs together with other photographs captured at the same geographic location and/or during the same day, various embodiments herein may allow the user to control the electronic device 100 to automatically select only the photographs that the child captured within the one-minute time span, without selecting the other photographs that are in the group (e.g., electronic gallery) that was automatically selected by the electronic device 100.

Referring now to FIG. 3O, operations of selecting (Block 330) the second one A of the files may include detecting (Block 330O-1) horizontal movement of the user object of the user, after the electronic device 100 accepts (Block 320) the user's selection of the first one S of the files. Moreover, the operations of selecting (Block 330) the second one A of the files may include determining (Block 330O-2) whether to select adjacent ones A of the files preceding the first one S of the files or to select adjacent ones A of the files following the first one S of the files, based on the horizontal movement. The electronic device 100 may then select (Block 330O-3) one or more of the adjacent ones A of the files in response to the determination in Block 330O-2.

The horizontal movement may include, for example, a sliding movement, a swiping movement, a dragging movement, or a rotation movement. For example, referring to FIG. 4B, which will be described in detail below, after selecting File 5, the user may move the user object to the left (e.g., from File 5 toward File 4) on the display 254 to select files preceding File 5. On the other hand, the user may move the user object to the right (e.g., from File 5 toward File 6) on the display 254 to select files following File 5. In another example, the user may move the user object forward/upward (e.g., from File 5 toward File 2) on the display 254 to select files preceding File 5 and may move the user object backward/downward (e.g., from File 5 toward File 8) on the display 254 to select files following File 5, or vice versa.

Referring still to FIG. 3O, files preceding or following another file may be defined herein as files preceding or following the other file with respect to time (e.g., time of creation/storage) or location on the display 254. Accordingly, the electronic device 100 may select only adjacent ones of the files A preceding (e.g., before) the first one S of the files, or only adjacent ones of the files A following (e.g., after) the first one S of the files, based on the horizontal (e.g., with respect to a surface of the display 254/user interface 252) direction in which the user moves the user object after selecting the first one S of the files.

FIGS. 4A-4H illustrate screenshots of a display of an electronic device 100 according to some embodiments. Referring now to FIG. 4A, an example of presenting (Block 310) a group of files is illustrated. In particular, FIG. 4A illustrates that Files 1-9 are presented on the display 254 of the electronic device 100. The group, however, may include more or fewer than nine files. Accordingly, more or fewer than nine files may be illustrated on the display 254.

In some embodiments, some of the adjacent ones A of the files selected by the electronic device 100 may not be visible/presented on the display 254 at the same time as the first one S of the files that is selected by the user. For example, if a large number of adjacent A files is selected by the electronic device 100, then some of the adjacent A files may only be displayed on the display 254 by scrolling within a displayed page/folder or by selecting a preceding or following page. Alternatively, in some embodiments in which a large number of adjacent A files is selected by the electronic device 100, the adjacent A files may be reduced in size such that they all fit on the display 254 contemporaneously.

Referring still to FIG. 4A, the files may be, for example, documents (e.g., PDF documents) on a page (or in a folder), text messages, emails, audio (e.g., music, podcasts) files, video files, digital images I (e.g., digital photographs in a gallery), or other groups of electronic items accessible by the user via the display 254/user interface 252. Moreover, any of such types of files may be represented graphically on the display 254 as respective thumbnail views, which are described herein with respect to FIG. 3M.

Referring now to FIG. 4B, an example of accepting (Block 320) user selection of a first one S of the group of files is illustrated. In particular, FIG. 4B illustrates accepting selection by the user of File 5.

Referring now to FIG. 4C, an example of selecting (Block 330) one or more adjacent ones A of the group of files is illustrated. In particular, FIG. 4C illustrates that Files 4, 6, and 7 are selected by the electronic device 100 based on the user selection (in FIG. 4B) of File 5.

In some embodiments, an adjacent one A of the files may be defined as a file (e.g., a graphical representation of the file) having proximity in time to the first one S of the files. Accordingly, adjacent ones A of the files that are selected by the electronic device 100 may be files that are selected because of their proximity in time to the first one S of the files. For example, referring again to FIG. 4C, Files 4, 6, and 7 may be digital photographs that were captured by the camera 258 at times that are close (e.g., closer than times for Files 1-3, 8, and 9) to the time that the camera 258 captured a digital photograph corresponding to File 5. According to such embodiments, Files 1-9 may be in chronological order, with lower-numbered ones of the Files 1-9 being captured/taken earlier in time and higher-numbered ones of the Files 1-9 being captured/taken later in time, or vice versa.

In some embodiments, an adjacent one A of the files may be defined as a file (e.g., a graphical representation of the file) having physical proximity on the display 254 to the first one S of the files. Accordingly, adjacent ones A of the files that are selected by the electronic device 100 may be files that are selected because of their physical proximity to the first one S of the files. For example, referring still to FIG. 4C, Files 4 and 6 have closer physical proximity on the display 254 to File 5 than any of the other files. Files 3 and 7 may be defined herein as more adjacent each other than Files 2 and 8 are adjacent each other, even though the wrap-around arrangement of the files on the display 254 makes the two pairs appear to be similar distances apart. In other words, Files 2 and 8 may be considered less adjacent each other than Files 3 and 7 because Files 2 and 8 have more files (Files 3-7) ordered/numerically therebetween.

Referring now to FIG. 4D, an example of increasing (Block 330B) a quantity of adjacent ones A of the files that are selected is illustrated. In particular, as the user continues to select (e.g., as illustrated in FIG. 4B) File 5, the quantity of adjacent ones A of the files that are selected may increase. For example, as the user continues to select File 5, the quantity may increase from three (e.g., Files 4, 6, and 7 in FIG. 4C) to six (e.g., Files 1-4, 6, and 7 in FIG. 4D). The illustrated increase from three to six, however, is one non-limiting example, and, in some embodiments, the quantity may increase by one, two, three, four, five, six, seven, or more files as the user continues to directly/manually/individually select the first one S of the files.

Referring now to FIG. 4E, an example of presenting (Block 325) the menu 450 is illustrated. In particular, FIG. 4E illustrates presenting the menu 450 in response to accepting user selection (e.g., as illustrated in FIG. 4B) of File 5. The options 451-455 of the menu 450 may include a first option 451 to select the second one (or more) A of the files based on proximity in time to the first one S of the files. Additionally or alternatively, the options 451-455 may include a second option 452 to select the second one (or more) A of the files based on physical proximity on the display 254 to the first one S of the files. Additionally or alternatively, the options 451-455 may include a third option 453 to select the second one (or more) A of the files based on a geographic location associated with the first one S of the files. Additionally or alternatively, the options 451-455 may include a fourth option 454 to select the second one (or more) A of the files based on an image of a human face that is included in the first one (S) of the files. Additionally or alternatively, the options 451-455 may include a fifth option 455 to select the second one (or more) A of the files based on a multi-image burst that includes the first one S of the files.

Referring now to FIG. 4F, an example of unselecting (Block 355/355) adjacent ones A of the files is illustrated. For example, the user may unselect File 7 of FIG. 4C to provide FIG. 4F's revised selection of adjacent A Files 4 and 6. In another example, the user may unselect Files 1-3 and 7 of FIG. 4D to provide FIG. 4F's revised selection of adjacent A Files 4 and 6.

Referring now to FIG. 4G, an example of presenting (Block 340) the menu 460 is illustrated. In particular, FIG. 4G illustrates presenting the menu 460 in response to selecting/unselecting (e.g., as illustrated in FIGS. 4C, 4F) adjacent ones A of the files. Specifically, FIG. 4G illustrates presenting the menu 460 to provide the options 461-464 with respect to adjacent A Files 4 and 6 and/or first-selected S File 4.

The options 461-464 of the menu 460 may include a first option 461 to send the second one (or more) A of the files and/or the first one S of the files in a message. The message may be an email, a text message (e.g., MMS, SMS, or other text message), or other form of electronic message that can be transmitted from the electronic device 100 via the network 110 illustrated in FIG. 1A. Additionally or alternatively, the options 461-464 may include a second option 462 to delete the second one (or more) A of the files and/or the first one S of the files. Additionally or alternatively, the options 461-464 may include a third option 463 to move and/or copy the second one (or more) A of the files and/or the first one S of the files to a memory 253 location within the electronic device 100. Additionally or alternatively, the options 461-464 may include a fourth option 464 to unselect the second one (or more) A of the files.

Referring now to FIG. 4H, an example of selecting digital images I (e.g., digital photographs) is illustrated. In particular, FIG. 4H illustrates two adjacent ones A of the digital images I that are selected by the electronic device 100 based on a selection by the user of a first one S of the digital images I. The adjacent ones A of the digital images I may be selected based on (a) chronological proximity to the first one S of the digital images, (b) physical proximity on the display 254 to the first one S of the digital images, (c) being associated with the same geographic location as the first one S of the digital images, (d) including the same person's face as the first one S of the digital images, and/or (e) being in multi-image burst that includes the first one S of the digital images.

### Examples of Embodiments in an Electronic Device (100)

According to some embodiments, a method of operating an electronic device (100) may be provided. The method may include presenting (310) a group of files on a display (254) of the electronic device (100). The method may include accepting (320) selection by a user, via a user interface (252) of the electronic device (100), of a first one (S) of the files. Moreover, the method may include, based on the selection of the first one (S) of the files by the user, selecting (330) a second one (A) of the files adjacent the first one (S) of the files.

The user interface (252) may include a touch screen interface of the display (254), and accepting (320) the selection may include accepting (320B) the selection by the user, via the touch screen interface, of the first one (S) of the files. Moreover, selecting (330) the second one (A) of the files may include selecting (330B) the second one (A) of the files in response to the user continuing to select, via the touch screen interface, the first one (S) of the files, after the electronic device (100) accepts (320B) the selection of the first one (S) of the files.

Selecting (330) the second one (A) of the files may include selecting a plurality of second ones (A) of the files and increasing (330B′) a quantity of the plurality of second ones (A) of the files that are selected adjacent the first one (S) of the files, in response to a quantity of time that the user continues to select the first one (S) of the files.

Selecting (330) the second one (A) of the files may include highlighting (330D) the second one (A) of the files on the display (254) and highlighting the first one (S) of the files on the display (254), based on the selection of the first one (S) of the files by the user.

Selecting (330) the second one (A) of the files may include highlighting (330D′) the second one (A) of the files on the display (254) when the user is continuing to select the first one (S) of the files.

Continuing to select the first one (S) of the files may include detection of holding (330B, 330B′, 330B″, 330D′) a user object of the user on or adjacent a location of the first one (S) of the files on the display (254).

The method may include presenting (325) a menu (450) including one or more options (451-455) for selecting within the group of files, responsive to the selection by the user of the first one (S) of the files. Moreover, selecting (330) the second one (A) of the files may include selecting (330B″) the second one (A) of the files in response to detection of the user continuing to select the first one (S) of the files for a threshold amount of time after presenting (325) the menu (450).

The selection of the first one (S) of the files by the user may include a selection of a thumbnail view of the first one (S) of the files by the user, and selecting (330) the second one (A) of the files may include selecting (330M) a thumbnail view of the second one (A) of the files based on the selection of the thumbnail view of the first one (S) of the files by the user.

The second one (A) of the files may be a file having proximity in time to the first one (S) of the files. Selecting (330) the second one (A) of the files may include increasing (330N-2) a time range before and/or after creation of the first one (S) of the files, in response to a quantity of time that the user continues (330N-1) to select the first one (S) of the files. Moreover, selecting (330) the second one (A) of the files may include selecting (330N-3) each one of the files that were created within the time range.

The second one (A) of the files may be a file having physical proximity on the display (254) to the first one (S) of the files.

The group of files may include a group of digital images (I), and presenting (310) the group of files may include presenting (310H) the group of digital images (I) on the display (254). Accepting (320) the selection may include accepting (320H) a selection by the user of a first one (S) of the digital images (I). Selecting (330) the second one (A) of the files may include selecting (330H) a second one (A) of the digital images (I) adjacent the first one (S) of the digital images (I), based on the selection of the first one (S) of the digital images (I) by the user. Moreover, the method may include obtaining (300) the digital images (I) using a camera (258) of the electronic device (100), before presenting (310) the group of digital images (I) on the display (254).

The first one (S) of the digital images (I) may be associated with a geographic location, and the second one (A) of the digital images (I) may be associated with the geographic location.

The second one (A) of the digital images (I) may be a digital image (I) including a human face that is included in the first one (S) of the digital images (I).

The second one (A) of the digital images (I) may include a plurality of the digital images (I) that were obtained in a multi-image burst that includes the first one (S) of the digital images (I). The multi-image burst may have been obtained, using the camera (258), within a threshold amount of time. Selecting (330) the second one (A) of the digital images (I) may include selecting the multi-image burst based on the selection of the first one (S) of the digital images (I) by the user.

The method may include presenting (325) a menu (450) including one or more options (451-455) for selecting within the group of files, after the selection by the user of the first one (S) of the files. The method may include accepting (326) selection by the user, via the user interface (252), of one of the options (451-455) from the menu (450). The options (451-455) may include a first option (451) to select the second one (A) of the files based on proximity in time to the first one (S) of the files. Additionally or alternatively, the options (451-455) may include a second option (452) to select the second one (A) of the files based on physical proximity on the display (254) to the first one (S) of the files. Additionally or alternatively, the options (451-455) may include a third option (453) to select the second one (A) of the files based on a geographic location associated with the first one (S) of the files. Additionally or alternatively, the options (451-455) may include a fourth option (454) to select the second one (A) of the files based on an image of a human face that is included in the first one (S) of the files. Additionally or alternatively, the options (451-455) may include a fifth option (455) to select the second one (A) of the files based on a multi-image burst that includes the first one (S) of the files. Moreover, selecting (330) the second one (A) of the files may include selecting (330G) the second one (A) of the files according to the selection of the one of the options (451-455) from the menu (450).

The method may include presenting (340) on the display (254) a menu (460) of one or more options (461-464) for the second one (A) of the files and/or the first one (S) of the files, after selecting (330) the second one (A) of the files. The options (461-464) may include a first option (461) to send the second one (A) of the files and/or the first one (S) of the files in a message. Additionally or alternatively, the options (461-464) may include a second option (462) to delete the second one (A) of the files and/or the first one (S) of the files. Additionally or alternatively, the options (461-464) may include a third option (463) to move and/or copy the second one (A) of the files and/or the first one (S) of the files to a memory (253) location within the electronic device (100). Additionally or alternatively, the options (461-464) may include a fourth option (464) to unselect the second one (A) of the files.

The method may include accepting un-selection of the second one (A) of the files by detecting re-selection (355′) of the first one (S) of the files via the touch screen interface, after selection of the first (S) and second (A) ones of the files.

The method may include accepting un-selection of the second one (A) of the files by detecting positioning (355) of a user object of the user on or adjacent a location of the second one (A) of the files on the display (254), after selection of the first (S) and second (A) ones of the files.

The group of files may be an automatically-selected group of files. The first (S) and second (A) ones of the files may be adjacent first (S) and second (A) ones of the files within the automatically-selected group of files. Moreover, selecting (330) the second one (A) of the files may include automatically selecting (330L) the second one (A) of the files within the automatically-selected group of files based on the selection by the user of the first one (S) of the files within the automatically-selected group of files.

Selecting (330) the second one (A) of the files may include detecting (330O-1) horizontal movement of a user object of the user, after the electronic device (100) accepts (320) the selection of the first one (S) of the files. Moreover, selecting (330) the second one (A) of the files may include determining (330O-2) whether to select adjacent ones (A) of the files preceding the first one (S) of the files or to select adjacent ones (A) of the files following the first one (S) of the files, based on the horizontal movement.

An electronic device (100) may be provided. The electronic device (100) may include a display (254), a user interface (252) configured to provide navigation of the display (254) by a user of the electronic device (100), and a processor (251). The processor (251) may be configured to present (310) a group of files on the display (254). The processor (251) may be configured to accept (320) selection by the user, via the user interface (252), of a first one (S) of the files. Moreover, the processor (251) may be configured to, based on the selection of the first one (S) of the files by the user, select (330) a second one (A) of the files that is adjacent the first one (S) of the files.

A computer program product may be provided. The computer program product may include a tangible computer readable storage medium including computer readable program code therein that when executed by a processor (251) causes the processor (251) to perform operations including presenting (310) a group of files on a display (254) of an electronic device (100). The operations may include accepting (320) selection by a user, via a user interface (252) of the electronic device (100), of a first one (S) of the files. Moreover, the operations may include, based on the selection of the first one (S) of the files by the user, selecting (330) a second one (A) of the files that is adjacent the first one (S) of the files.

In the above-description of various embodiments of present inventive concepts, it is to be understood that the terminology used herein is for the purpose of describing particular embodiments only and is not intended to be limiting of inventive concepts. Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

It will be understood that, although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, elements, steps, components or functions but does not preclude the presence or addition of one or more other features, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit (also referred to as a processor) of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of present inventive concepts. All such variations and modifications are intended to be included herein within the scope of present inventive concepts. Accordingly, the above-disclosed subject matter is to be considered illustrative, and not restrictive, and the following claims are intended to cover all such modifications, enhancements, and other embodiments, which fall within the spirit and scope of present inventive concepts.

1. A method of operating an electronic device, the method comprising:
presenting a group of files on a display of the electronic device;
accepting selection by a user, via a user interface of the electronic device, of a first one of the files; and
based on the selection of the first one of the files by the user, selecting a second one of the files adjacent the first one of the files.

2. The method of claim 1,
wherein the user interface comprises a touch screen interface of the display,
wherein accepting the selection comprises accepting the selection by the user, via the touch screen interface, of the first one of the files, and
wherein selecting the second one of the files comprises selecting the second one of the files in response to the user continuing to select, via the touch screen interface, the first one of the files, after the electronic device accepts the selection of the first one of the files.

3. The method of claim 2, wherein selecting the second one of the files comprises selecting a plurality of second ones of the files and increasing a quantity of the plurality of second ones of the files that are selected adjacent the first one of the files, in response to a quantity of time that the user continues to select the first one of the files.

4. The method of claim 1, wherein selecting the second one of the files comprises highlighting the second one of the files on the display and highlighting the first one of the files on the display, based on the selection of the first one of the files by the user.

5. The method of claim 2, wherein selecting the second one of the files comprises highlighting the second one of the files on the display when the user is continuing to select the first one of the files.

6. The method of claim 2, wherein continuing to select the first one of the files comprises detection of holding a user object of the user on or adjacent a location of the first one of the files on the display.

7. The method of claim 2, further comprising:
presenting a menu comprising options for selecting within the group of files, responsive to the selection by the user of the first one of the files,
wherein selecting the second one of the files comprises selecting the second one of the files in response to detection of the user continuing to select the first one of the files for a threshold amount of time after presenting the menu.

8. The method of claim 1,
wherein the selection of the first one of the files by the user comprises a selection of a thumbnail view of the first one of the files by the user, and
wherein selecting the second one of the files comprises selecting a thumbnail view of the second one of the files based on the selection of the thumbnail view of the first one of the files by the user.

9. The method of claim 1, wherein the second one of the files comprises a file having proximity in time to the first one of the files.

10. The method of claim 9, wherein selecting the second one of the files comprises:
increasing a time range before and/or after creation of the first one of the files, in response to a quantity of time that the user continues to select the first one of the files; and
selecting each one of the files that were created within the time range.

11. The method of claim 1, wherein the second one of the files comprises a file having physical proximity on the display to the first one of the files.

12. The method of claim 1,
wherein the group of files comprises a group of digital images,
wherein presenting the group of files comprises presenting the group of digital images on the display,
wherein accepting the selection comprises accepting a selection by the user of a first one of the digital images,
wherein selecting the second one of the files comprises selecting a second one of the digital images adjacent the first one of the digital images, based on the selection of the first one of the digital images by the user, and
wherein the method further comprises obtaining the digital images using a camera of the electronic device, before presenting the group of digital images on the display.

13. The method of claim 12,
wherein the first one of the digital images is associated with a geographic location, and
wherein the second one of the digital images is associated with the geographic location.

14. The method of claim 12, wherein the second one of the digital images comprises a digital image comprising a human face that is included in the first one of the digital images.

15. The method of claim 12,
wherein the second one of the digital images comprises a plurality of the digital images that were obtained in a multi-image burst that includes the first one of the digital images,
wherein the multi-image burst was obtained, using the camera, within a threshold amount of time, and
wherein selecting the second one-of the digital images comprises selecting the multi-image burst based on the selection of the first one of the digital images by the user.

16. The method of claim 1, further comprising:
presenting a menu comprising options for selecting within the group of files, after the selection by the user of the first one of the files; and
accepting selection by the user, via the user interface, of one of the options from the menu,
wherein the options comprise at least one of:
a first option to select the second one of the files based on proximity in time to the first one of the files;
a second option to select the second one of the files based on physical proximity on the display to the first one of the files;
a third option to select the second one of the files based on a geographic location associated with the first one of the files;
a fourth option to select the second one of the files based on an image of a human face that is included in the first one of the files; and
a fifth option to select the second one of the files based on a multi-image burst that includes the first one of the files, and
wherein selecting the second one of the files comprises selecting the second one of the files according to the selection of the one of the options from the menu.

17. The method of claim 1, further comprising:
presenting on the display a menu of options for the second one of the files and/or the first one of the files, after selecting the second one of the files,
wherein the options comprise at least one of:
a first option to send the second one of the files and/or the first one of the files in a message;
a second option to delete the second one of the files and/or the first one of the files;
a third option to move and/or copy the second one of the files and/or the first one of the files to a memory location within the electronic device; and
a fourth option to unselect the second one of the files.

18. The method of claim 2, further comprising:
accepting un-selection of the second one of the files by detecting re-selection of the first one of the files via the touch screen interface, after selection of the first and second ones of the files.

19. The method of claim 2, further comprising:
accepting un-selection of the second one of the files by detecting positioning of a user object of the user on or adjacent a location of the second one of the files on the display, after selection of the first and second ones of the files.

20. The method of claim 1,
wherein the group of files comprises an automatically-selected group of files,
wherein the first and second ones of the files comprise adjacent first and second ones of the files within the automatically-selected group of files, and
wherein selecting the second one of the files comprises automatically selecting the second one of the files within the automatically-selected group of files based on the selection by the user of the first one of the files within the automatically-selected group of files.

21. The method of claim 1, wherein selecting the second one of the files comprises:
detecting horizontal movement of a user object of the user, after the electronic device accepts the selection of the first one of the files; and
determining whether to select adjacent ones of the files preceding the first one of the files or to select adjacent ones of the files following the first one of the files, based on the horizontal movement.

22. An electronic device, comprising:
a display;
a user interface configured to provide navigation of the display by a user of the electronic device; and
a processor configured to
present a group of files on the display;
accept selection by the user, via the user interface, of a first one of the files; and
based on the selection of the first one of the files by the user, select a second one-of the files that is adjacent the first one of the files.

23. A computer program product, comprising:
a tangible computer readable storage medium comprising computer readable program code therein that when executed by a processor causes the processor to perform operations comprising:
presenting a group of files on a display of an electronic device;
accepting selection by a user, via a user interface of the electronic device, of a first one of the files; and
based on the selection of the first one of the files by the user, selecting a second one of the files that is adjacent the first one of the files.
